(19) United States
(12) Patent Application Publication
(10) Pub. No.: US 2019/0036703 A1
(43) Pub. Date: Jan. 31, 2019

(54) SHARD GROUPS FOR EFFICIENT UPDATES OF, AND ACCESS TO, DISTRIBUTED METADATA IN AN OBJECT STORAGE SYSTEM

(71) Applicant: NEXENTA SYSTEMS, INC., Santa Clara, CA (US)

(72) Inventor: Caitlin BESTLER, Sunnyvale, CA (US)

(73) Assignee: NEXENTA SYSTEMS, INC., Santa Clara, CA (US)

(21) Appl. No.: 15/662,751

(22) Filed: Jul. 28, 2017

(51) Int. Cl. H04L 9/32; G06F 17/30; H04L 29/08; H04L 12/18

(52) U.S. Cl. CPC H04L 9/3242; G06F 17/3012; H04L 12/185; G06F 17/30215; G06F 17/30159; H04L 67/1097

(57) ABSTRACT

The present disclosure provides techniques for efficiently updating and searching sharded key-value record stores in an object storage cluster. The disclosed techniques use shard groups, instead of using negotiating groups and rendezvous groups as in a previously-disclosed multicast replication technique. The use of shard groups results in fewer messages being required to complete an update or a search than would have been required using the previously-disclosed technique. The use of shard groups is particularly beneficial when applied to system maintained objects, such as a namespace manifest.

### TECHNICAL FIELD

The present disclosure relates to object storage systems with distributed metadata.

### BACKGROUND

With the increasing amount of data is being created, there is increasing demand for data storage solutions. Storing data using a cloud storage service is a solution that is growing in popularity. A cloud storage service may be publicly-available or private to a particular enterprise or organization.

A cloud storage system may be implemented as an object storage cluster that provides “get” and “put” access to objects, where an object includes a payload of data being stored. The payload of an object may be stored in parts referred to as “chunks”. Using chunks enables the parallel transfer of the payload and allows the payload of a single large object to be spread over multiple storage servers.

Metadata for objects stored in a conventional object storage cluster may be stored and accessed centrally. Recently, consistent hashing has been used to eliminate the need for such centralized metadata. Instead, the metadata may be distributed over multiple storage servers in the object storage cluster.

Object storage clusters may use multicast messaging within a small set of storage targets to dynamically load-balance assignments of new chunks to specific storage servers and to choose which replica will be read for a specific get transaction. An exemplary implementation of an object storage cluster using multicast messaging within a small set of storage targets is described in: U.S. Pat. No. 9,338,019 (“Scalable Transport Method for Multicast Replication,” inventors Caitlin Bestler et al.); U.S. Pat. No. 9,344,287 (“Scalable Transport System for Multicast Replication,” inventors Caitlin Bestler et al.); U.S. Pat. No. 9,385,874 (“Scalable Transport with Client-Consensus Rendezvous,” inventors Caitlin Bestler et al.); and U.S. Pat. No. 9,385,875 (“Scalable Transport with Cluster-Consensus Rendezvous,” inventors Caitlin Bestler et al.). The disclosure of the aforementioned four patents (hereinafter referred to as the “Multicast Replication” patents) are hereby incorporated by reference.

### SUMMARY

The present disclosure provides techniques for efficiently updating and searching sharded key-value record stores in an object storage cluster. The disclosed techniques use shard groups, instead of using negotiating groups and rendezvous groups as in a previously-disclosed multicast replication technique. The use of shard groups results in fewer messages being required to complete an update or a search than would have been required using the previously-disclosed technique. The use of shard groups is particularly beneficial when applied to system maintained objects, such as a namespace manifest.

### BRIEF DESCRIPTION OF THE DRAWINGS

FIG. 1 is a flow chart of an example of a prior method of updating namespace manifest shards in an object storage cluster with multicast replication.

FIG. 2 is a flow chart of a method of using a shard group to update a namespace manifest shard in an object storage cluster with multicast replication in accordance with an embodiment of the invention.

FIG. 3 is a flow chart of a method of maintaining the shard group in accordance with an embodiment of the invention.

FIG. 4 is a flow cart of a method of performing a namespace query transaction when using the shard group associated with a namespace manifest shard in accordance with an embodiment of the invention.

FIG. 5 is a flow chart of a method of using a shard group to update key-value records in a shard of an object stored in an object storage cluster with multicast replication in accordance with an embodiment of the invention.

FIG. 6 is a flow cart of a method of performing a key-value record query transaction when using the shard group in accordance with an embodiment of the invention.

FIG. 7 depicts an exemplary object storage system in which the presently-disclosed solutions may be implemented.

FIG. 8 depicts a distributed namespace manifest and local transaction logs for each storage server of an exemplary storage system in which the presently-disclosed solutions may be implemented.

FIG. 9A depicts an exemplary relationship between an object name received in a put operation, namespace manifest shards, and the namespace manifest.

FIG. 9B depicts an exemplary structure of one types of entry that can be stored in a namespace manifest shard.

FIG. 9C depicts an exemplary structure of another type of entry that can be stored in a namespace manifest shard.

FIG. 10 depicts a hierarchical structure for the storage of an object into chunks in accordance with embodiment of the invention.

FIG. 11 depicts key-value tuples (KVTs) that are used to implement the hierarchical structure of FIG. 10 in accordance with an embodiment of the invention.

FIG. 12 depicts KVT entries that allow tracking of all the objects to which a payload chunk belongs.

FIG. 13 is a simplified diagram showing components of a computer apparatus that may be used to implement elements (including, for example, client computers, gateway servers and storage servers) of an object storage system.

### DETAILED DESCRIPTION

The above-referenced Multicast Replication patents disclose a multicast replication technique that is efficient for the update of objects defined as containing byte arrays. However, an object storage cluster with distributed metadata may also store objects that are defined as containing key-value records, and, as disclosed herein, the previously-disclosed multicast replication technique can be highly inefficient for updating objects that store key-value records.

Key-value records may be used internally by the system to the storage cluster track metadata, such as naming metadata for objects stored in the system. An exemplary implementation of an object storage cluster using key-value records to store naming metadata is described in United States Patent Application Publication No. US 2017/0123931 A1 (“Object Storage System with a Distributed Namespace and Snapshot and Cloning Features,” inventors Alexander Aizman and Caitlin Bestler), the disclosure of the aforementioned patent (hereinafter referred to as the “Distributed Namespace” patent) is hereby incorporated by reference. Key-value records may also be user supplied. User-supplied key-value records may be extending an object application programming interface (API), such as Amazon S3™ or the OpenStack Object Storage (Swift) System™.

An object storage cluster may, in general, allow objects defined as containing key-value records to be sharded based on the hash of the record key, rather than on byte offsets. An exemplary implementation of an object storage cluster storing such “key sharded” objects is described in United States Patent Application Publication No. US 2016/0191509 A1 (“Methods and Systems for Key Sharding of Objects Stored in Distributed Storage System,” inventors Caitlin Bestler et al.), the disclosure of the aforementioned patent (hereinafter referred to as the “Key Sharding” patent) is hereby incorporated by reference.

Applicant has determined that the previously-disclosed multicast replication technique (disclosed in the above-referenced patents) is efficient in updating objects defined as byte arrays and less efficient for updating objects defined as key-value records. This is because each transaction that modifies of a shard of an object with key-value records (i.e. each update to the shard) is very likely to create a new image of the shard that is composed mostly of pre-transaction records. Because most records are retained from the pre-transaction image, changing the locations (i.e. changing the servers) storing the shard is highly costly in terms of system resources.

Furthermore, the bidding process to select the new locations to store the new image of the shard is extremely likely to select the same locations that stored the pre-transaction image. This is because those locations already store most of the data in the new image of the shard and so do not need to obtain that data from other locations. Hence, engaging in the bidding process itself is also generally a waste of system resources.

The present disclosure provides extensions to the multicast replication technique for efficiently maintaining and searching sharded key-value record stores. These extensions result in fewer messages being required to complete an update or a search than would have been required using the previously-disclosed multicast replication technique. These extensions are particularly beneficial when applied to system maintained objects, such as a namespace manifest.

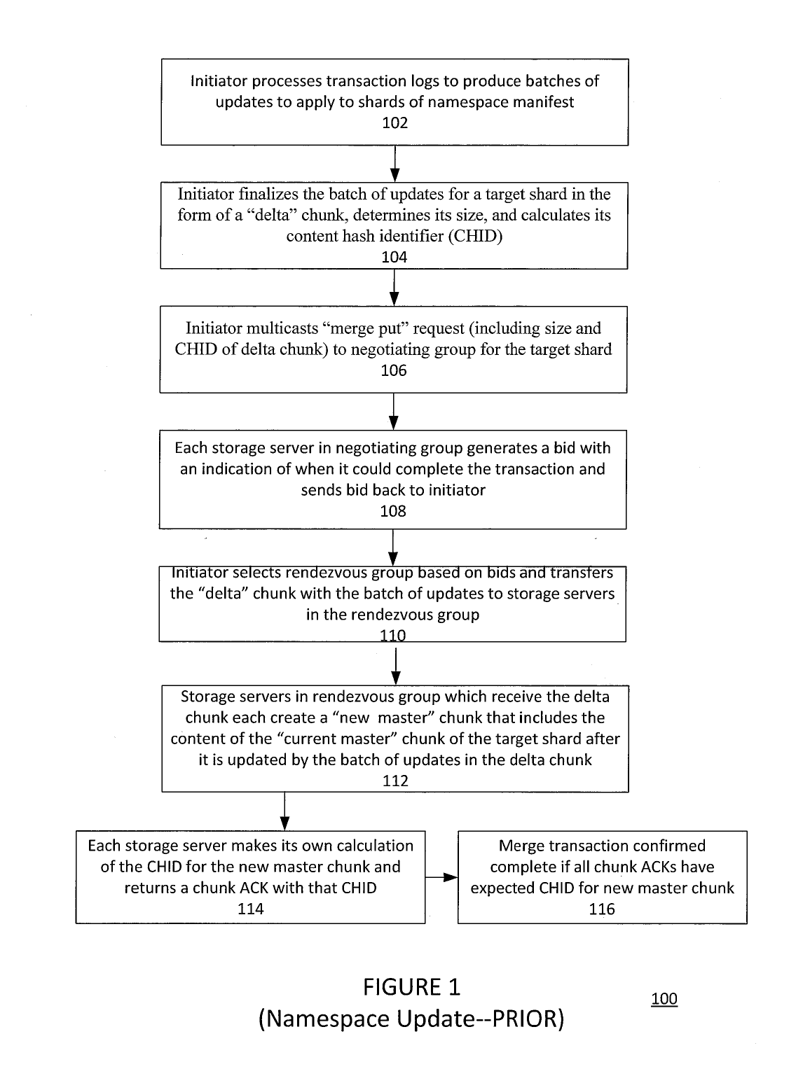

In an object storage system with multicast replication, transaction logs on storage servers may be processed to produce batches of updates to namespace manifest shards. These batches may be applied to the namespace manifest shards using procedures to put objects or chunks under the previously-disclosed multicast replication technique. An example of a prior method 100 of updating namespace manifest shards in an object storage cluster with multicast replication is shown in FIG. 1.

The initiator is the storage server that is generating the transaction batch. Per step 102, the initiator may process transaction logs to produce batches of updates to apply to shards of a target object. Per step 104, the initiator finalizes the batch of updates for a target shard in the form of a “delta” chunk, determines its size, and calculates its content hash identifier (CHID), which may also be referred to as a content hash identifying token (CHIT).

Per step 106, the Initiator multicasts “merge put” request (including size and CHID of delta chunk) to the negotiating group for the target shard. Per step 108, each storage server in the negotiating group generates a bid with an indication of when it could complete the transaction and sends the bid back to the initiator.

Per step 110, the initiator selects the rendezvous group based on the bids and transfers the “delta” chunk with the batch of updates to the storage servers in the rendezvous group. Per step 112, each of the storage servers in the rendezvous group which receives the delta chunk creates a “new master” chunk. The new master chunk includes the content of the “current master” chunk of the target shard after it is updated by the batch of updates in the delta chunk.

Per step 114, each storage server makes its own calculation of the CHID for the new master chunk and returns a chunk acknowledgement message (ACK) with that CHID. Finally, the merge transaction may be confirmed complete by the initiator if all chunk ACKs have the expected CHID for the new master chunk.

The above-described prior method 100 uses both a negotiating group and a rendezvous group to dynamically pick a best set of storage servers within the negotiating group to generate a rendezvous group for each rendezvous transfer. The rendezvous transfers are allowed to overlap. The assumption is that each chunk put to the negotiating group will be assigned based on chaotic short-term considerations, making the selections appear to be pseudo-random when examined long after the chunks have been put.

However, scheduling acceptance of merge transaction batches to a shard group, as disclosed herein, has the substantially different goal of accepting the same transaction batches (delta chunks) at all members of the shard group, and in the same order. In this case, load balancing is not the goal, rather the goal is finding when the earliest mutually compatible delivery window is. Each target server in the shard group still reconciles the required reservation of persistent storage resources and network capacity with other multicast replication transactions that the target server is performing concurrently.

Shard groups may be pre-provisioned when a sharded object is provisioned. The shard group may be pre-provisioned when the associated namespace manifest shard is created. In an exemplary implementation, an additional all-shards group may also be provisioned to support query transactions which cannot be confined to a single shard.

When a shard group has been provisioned, the information mapping from the object name and shard number to the associated shard group may be included in system configuration data replicated to all cluster participants as a management plane operation. In particular, a management plane configuration rule may be used to enumerate the server members in the shard group associated with a specified shard number of a specified object name.

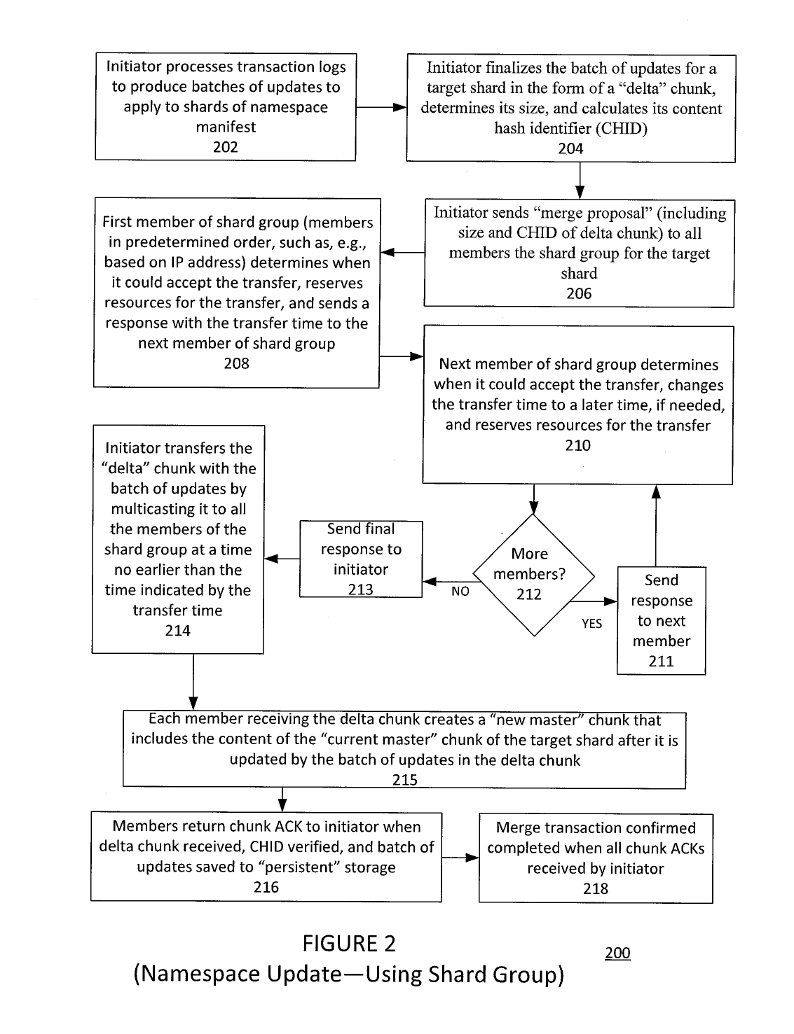

An exemplary method 200 of using a shard group to update a namespace manifest shard in an object storage cluster with multicast replication is shown in the flow chart of FIG. 2. The method 200 is advantageously efficient in that it requires substantially fewer required messages to accomplish the update than would be needed by the prior method 100.

Steps 202 and 204 in the method 200 of FIG. 2 are like steps 102 and 104 in the prior method 100. Per step 202, the initiator may process transaction logs to produce batches of updates to apply to the shards of namespace manifest. Each update may include new records to store in the namespace manifest shard and/or changes to existing records in the namespace manifest shard. Per step 204, the initiator finalizes the batch of updates for a target shard in the form of a “delta” chunk, determines its size, and calculates its content hash identifier (CHID).

The method 200 of FIG. 2 diverges from the prior method 100 starting at step 206. Per step 206, the initiator sends a “merge proposal” (including size and CHID of delta chunk) to all members the shard group for the target shard. The merge proposal may be sent by multicasting it to all members of the shard group. Alternatively, the merge proposal may be sent to a first member of the shard group, then forwarded to a second member, then forwarded to a third member, and so on, until all members of the shard group have received it. This step differs substantially from step 106 in the prior method 100 which multicasts a merge put to the negotiating group.

Per step 208, a first member of shard group may determine when it could accept the transfer, reserve resources for the transfer, and send a response with the transfer time to the next member of the shard group. The ordering of the members of the shard group may be predetermined. For example, the order may be based on the IP address, going from lowest to highest.

Per step 210, the next member of shard group determines when it could accept the transfer and changes the transfer time to a later time, if needed. In addition, this member reserves local resources for the transfer. Per step 211, a determination is made as to whether there are further members of the shard group. In other words, a determination is made as to whether any members of the shard group have not yet received the response. If there are more members, then this member sends a response with the transfer time to the next member of shard group per step 212, and the method 200 loops back to step 210. On the other hand, if there are no further members, then this last member sends a final response with the transfer time to the initiator per step 213. Per step 214, upon receiving the final response, the initiator transfers the delta chunk with the batch of updates by multicasting it to all the members of the shard group at a time no earlier than the time indicated by the transfer time.

Per step 215, each member receiving the delta chunk creates a “new master” chunk for the target shard of the namespace manifest. The new master chunk includes the content of the “current master” chunk of the shard after application of the update provided by the delta chunk. While the data in the new master chunk may be represented as a compact sorted array of the updated content, it may be represented in other ways. For example, the new master may be represented by a deferred linearization of the prior content and the content updates, where the two are merged and linearized on demand to fuse them into the data for the current master. Such deferred linearization of the new master chunk may be desirable to be applied reduce the amount of disk writing required; however, it does not reduce the amount of reading required since the entire chunk must be read to fingerprint it.

Per step 216, the members may return a chunk acknowledgement message (ACK) to the initiator when (i) the delta chunk is received, (ii) its CHID is verified (i.e. matches the CHID provided in the merge proposal), (ii) the batch of updates has been saved to “persistent” storage by the member. Saving the batch to persistent storage may be accomplished by either saving the batch to a queue of pending batches, or by merging the updates in the batch with the current master chunk for the namespace shard to create a new master chunk for the namespace shard. Finally, per step 218, the merge transaction is confirmed as completed when all chunk ACKs are received by the initiator.

Hence, the method 200 in FIG. 2 accepts the transaction batch at all members of the shard group at the earliest mutually compatible transfer time, and the merge transaction is confirmed as completed after the acknowledgements from all the members are received. Regarding multiple transaction batches, they are accepted in the same order by all the members of the shard group (i.e. the first batch is accepted by all members, then the second batch is accepted by all members, then the third batch is accepted by all members, and so on).

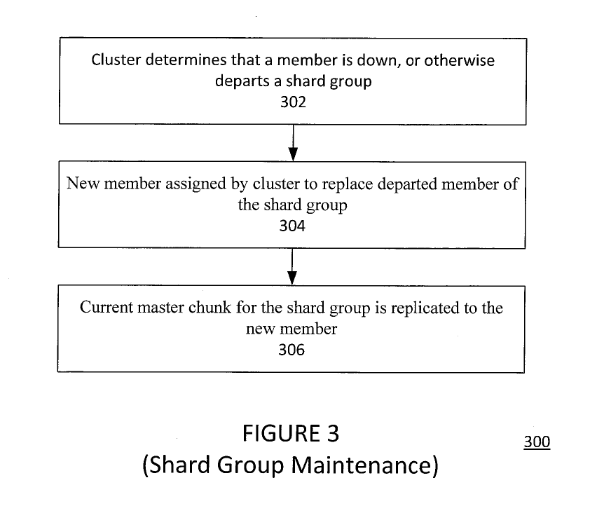

The object storage cluster operates to maintain the configured number of members in each shard group. New servers are assigned to be members of the group to replace departed members. FIG. 3 is a flow chart of a method 300 of maintaining the shard group in accordance with an embodiment of the invention.

Per step 302, the cluster may determine that a member of a shard group is down or has otherwise departed the shard group. Per step 304, a new member is assigned by the cluster to replace the departed member of the shard group. Per step 306, when a new member joins a shard group, one of the other members replicates the current master chunk for the shard to the new member.

In one implementation, new transaction batches are not accepted until the replication of the master chunk is complete. In another implementation, once the master chunk has been replicated, any transaction batches that have shown up in the interim are also replicated at the new member.

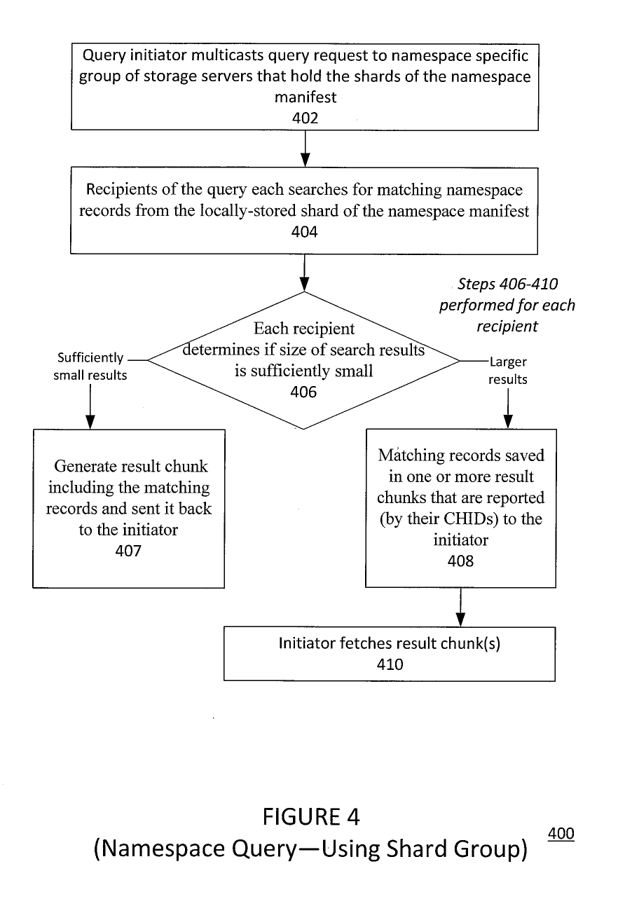

FIG. 4 is a flow cart of a method 400 of performing a namespace query transaction when using the shard group associated with a namespace manifest shard in accordance with an embodiment of the invention. Note that the query transaction described below in relation to FIG. 4 collects results from multiple shards. However, the results from the shards will vary greatly in size, and there is no apparent way for an initiator to predict which shards will be large, or take longer to generate, before initiating query. In many cases, the results from some shards are anticipated to be very small in size. Moreover, the query results must be generated before they can be transmitted. When the results are large in size, they may be stored locally as a chunk, or a series of chunks, before being transmitted. On the other hand, when the results are small in size (for example, only a few records), they may be sent immediately. A batch should be considered “large” if transmitting it over unreserved bandwidth would be undesirable. By contrast a “small” batch is sufficiently small that it is not worth the overhead to create a reserved bandwidth transmission.

Per step 402, the query initiator multicasts a query request to the namespace specific group of storage servers that hold the shards of the namespace manifest. In other words, the query request is multicast to the members of all the shard groups of the namespace manifest object. Note that, while sending the query to all the namespace manifest shards is the default, some queries may be limited to a single shard. In addition, the query may include an override on the maximum number of records to include in the response.

Per step 404, the recipients of the query each searches for matching namespace records from the locally-stored shard of the namespace manifest. Note that the locally-stored namespace manifest shard is a logical collection of records that includes the records in the current master chunk and any additional records that have not yet been consolidated into the current master.

Per step 406, a determination is made as to the size of the search results. If the total number of key-value records in the search results is sufficiently small, then an immediate response including these records in a result (or extract) chunk may be generated and sent by the query recipient back to the initiator per step 407. (In an exemplary implementation, there is an exception to sending an immediate response in the case of a logical rename record.) Otherwise, per step 408, the key-value records in the search result may be saved in a series of result chunks that are reported (by their CHIDs) to the initiator so that the initiator may fetch them per step 410. Note that all the result chunks may become expungable after the reservation to transmit them to the initiator completes.

Regarding logical rename records, when a logical rename record is found by the search that would take precedence over any rename already reported for this query, the storage server multicasts a notice of the logical rename record to the same group of target servers that the request was received upon. When the notice of the logical rename record is received by a target server, the target server determines whether this supersedes the current rename mapping (if any) that it is working on. If so, the target server will discard the current results chunk and restart the query with the remapped name.

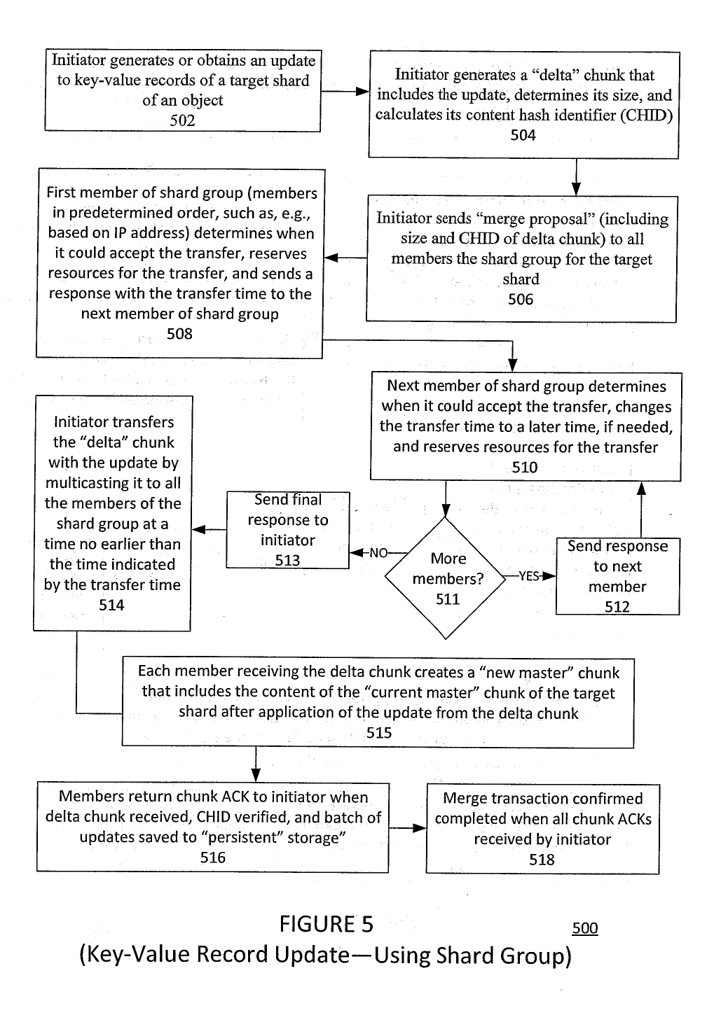

FIG. 5 is a flow chart of a method 500 of using a shard group to update key-value records in a shard of an object stored in an object storage cluster with multicast replication in accordance with an embodiment of the invention. The method 500 of updating records of an object in FIG. 5 is similar to the method 200 of updating records of the namespace manifest in FIG. 2.

Per step 502, the initiator generates or obtains an update to key-value records of a target shard of an object. The update may include new key-value records to store in the object shard and/or changes to existing key-value records in the object shard. Per step 504, the initiator generates a delta chunk that includes the update, determines its size, and calculates its content hash identifier (CHID). Per step 506, the initiator sends a “merge proposal” (including size and CHID of delta chunk) to all members the shard group for the target shard.

An additional variation is that the merge proposal may be sent to a first member of the shard group, then forwarded to a second member, then forwarded to a third member, and so on, until all members of the shard group have received it.

Per step 508, a first member of shard group may determine when it could accept the transfer, reserve resources for the transfer, and send a response with the transfer time to the next member of the shard group. The ordering of the members of the shard group may be predetermined. For example, the order may be based on the IP address, going from lowest to highest.

Per step 510, the next member of shard group detenuines when it could accept the transfer and changes the transfer time to a later time, if needed. In addition, this member reserves local resources for the transfer. Per step 511, a determination is made as to whether there are further members of the shard group. In other words, a determination is made as to whether any members of the shard group have not yet received the response. If there are more members, then this member sends a response with the transfer time to the next member of shard group per step 512, and the method 500 loops back to step 510. On the other hand, if there are no further members, then this last member sends a final response with the transfer time to the initiator per step 513. Per step 514, upon receiving the final response, the initiator transfers the delta chunk with the update by multicasting it to all the members of the shard group at a time no earlier than the time indicated by the transfer time.

Per step 515, each member receiving the delta chunk creates a “new master” chunk for the target shard. The new master chunk includes the content of the “current master” chunk of the shard after application of the update provided by the delta chunk.

Per step 516, the members may return a chunk acknowledgement message (ACK) to the initiator when (i) the delta chunk is received, (ii) its CHID is verified (i.e. matches the CHID provided in the merge proposal), (ii) the update has been saved to “persistent” storage by the member. Saving the update to persistent storage may be accomplished by either saving the update to a queue of pending updates, or by merging the update with the current master chunk for the object shard to create a new master chunk for the object shard. Finally, per step 518, the merge transaction is confirmed as completed when all chunk ACKs are received by the initiator.

An implementation may include an option to in-line the update with the Merge Request when the size of the update batch is sufficiently small that the overhead of negotiating the transfer of the batch is not justified. This is only desirable when the resulting multicast packet is still small. Multicasting to all members of the shard group is acceptable because all members of the group will be selected to apply the batch anyway. The immediate proposal is applied by the receiving targets beginning with step 514.

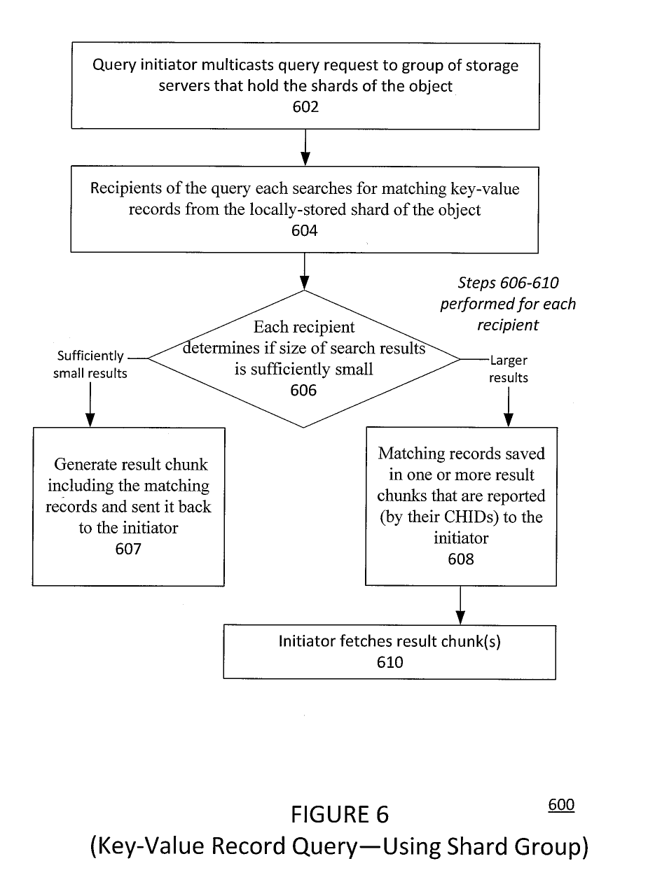

FIG. 6 is a flow cart of a method 600 of performing a key-value record query transaction when using the shard group in accordance with an embodiment of the invention. The method 600 for a key-value record query in FIG. 6 is similar to the method 400 for a namespace query in FIG. 4.

Per step 602, the query initiator multicasts a query request to the group of storage servers that hold the shards of the object. In other words, the query request is multicast to the members of all the shard groups of the object. Note that, while sending the query to all the shards is the default, some queries may be limited to a single shard. In addition, the query may include an override on the maximum number of records to include in the response.

Per step 604, the recipients of the query each searches for matching namespace records from the locally-stored shard of the namespace manifest. Note that the locally-stored namespace manifest shard is a logical collection of records that includes the records in the current master chunk and any additional records that have not yet been consolidated into the current master.

Per step 606, a determination is made as to the size of the search results. If the total number of key-value records in the search results is sufficiently small, then an immediate response including these records in a result (or extract) chunk may be generated and sent by the query recipient back to the initiator per step 607. (In an exemplary implementation, there is an exception to sending an immediate response in the case of a logical rename record.) Otherwise, per step 608, the key-value records in the search result may be saved in a series of result chunks that are reported (by their CHIDs) to the initiator so that the initiator may fetch them per step 610. Note that all the result chunks may become expungable after the reservation to transmit them to the initiator completes.

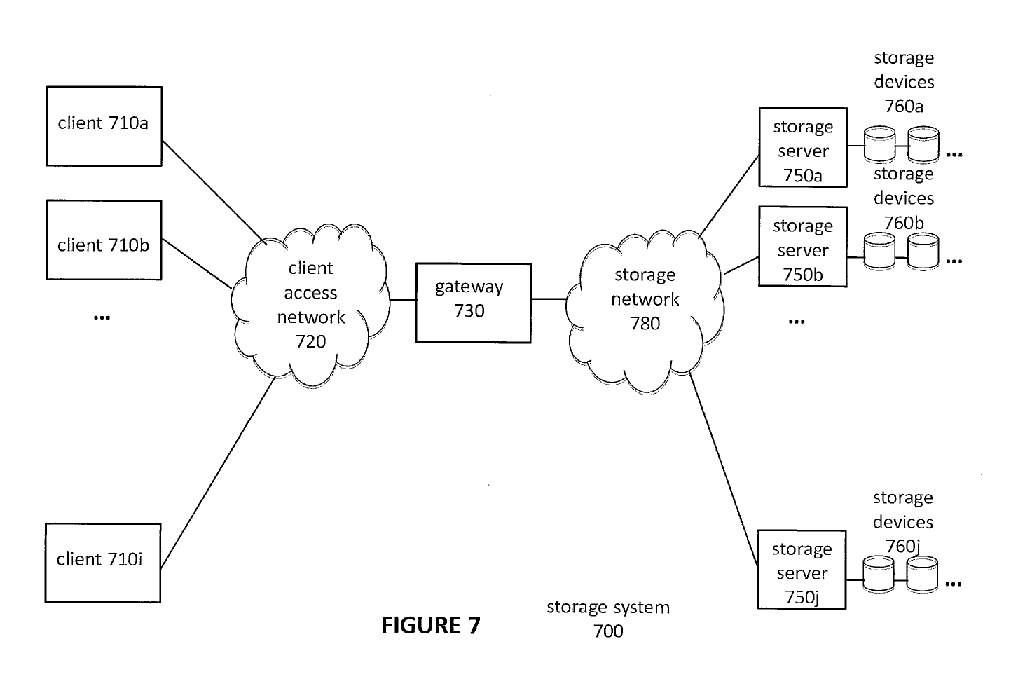

FIG. 7 depicts an exemplary object storage system 700 in which the presently-disclosed solutions may be implemented. The object storage system 700 supports hierarchical directory structures (i.e. hierarchical user directories) within its namespace. The namespace itself is stored as a distributed object. When a new object is added or updated as a result of a put transaction, metadata relating to the object's name may be (eventually or immediately) stored in a namespace manifest shard based on the partial key derived from the full name of the object.

The object storage system 700 comprises clients 710a, 710b, . . . 710i (where i is any integer value), which access gateway 730 over client access network 720. There can be multiple gateways and client access networks, and that gateway 730 and client access network 720 are merely exemplary. Gateway 730 in turn accesses Storage Network 740, which in turn accesses storage servers 750a, 750b, . . . 750j (where j is any integer value). Each of the storage servers 750a, 750b, . . . , 750j is coupled to a plurality of storage devices 760a, 760b, . . . , 760j, respectively.

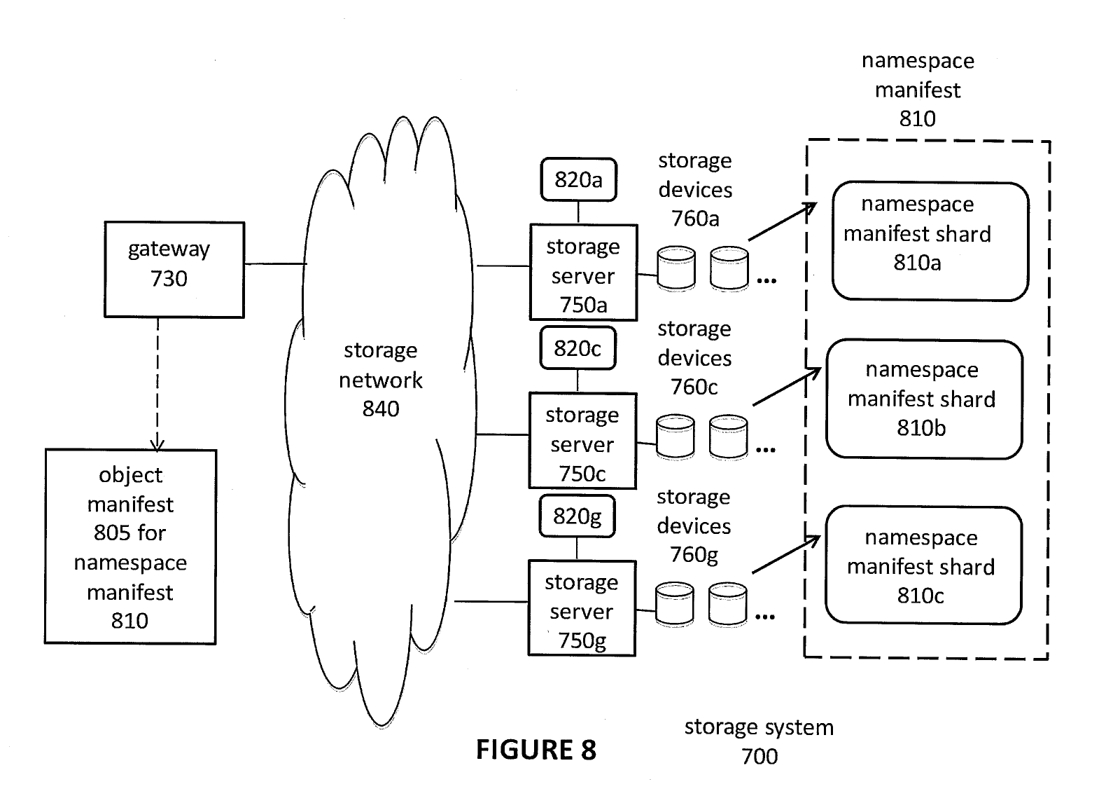

FIG. 8 depicts certain further aspects of the storage system 700 in which the presently-disclosed solutions may be implemented. As depicted, gateway 730 can access object manifest 805 for the namespace manifest 810. Object manifest 805 for namespace manifest 810 contains infoirnation for locating namespace manifest 810, which itself is an object stored in storage system 700. In this example, namespace manifest 810 is stored as an object comprising three shards, namespace manifest shards 810a, 410b, and 410c. This is representative only, and namespace manifest 810 can be stored as one or more shards. In this example, the object has been divided into three shards and have been assigned to storage servers 750a, 750c, and 750g. Typically each shard is replicated to multiple servers as described for generic objects in the Incorporated References. These extra replicas have been omitted to simplify the diagram.

The role of the object manifest 805 is to identify the shards of the namespace manifest 810. An implementation may do this either as an explicit manifest which enumerates the shards, or as a management plane configuration rule which describes the set of shards that are to exist for each managed namespace. An example of a management plane rule would dictate that the TenantX namespace was to spread evenly over twenty shards anchored on the name hash of “TenantX”.

In addition, each storage server maintains a local transaction log. For example, storage server 750a stores transaction log 820a, storage server 750c stores transaction log 820c, and storage server 750g stores transaction log 820g.

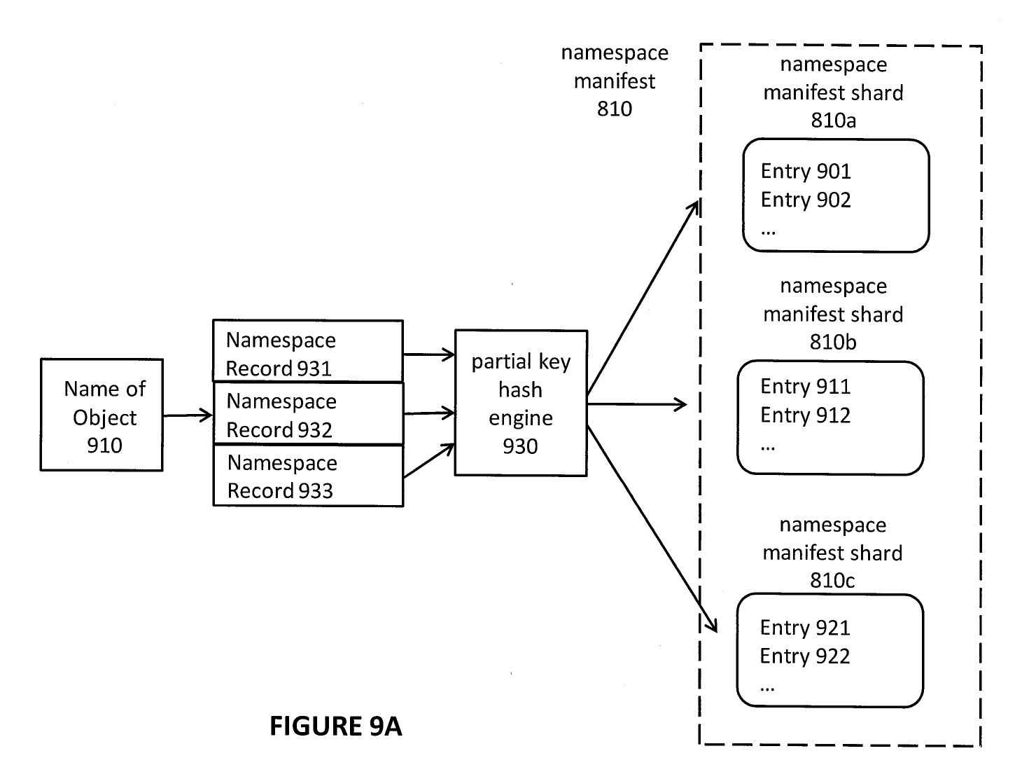

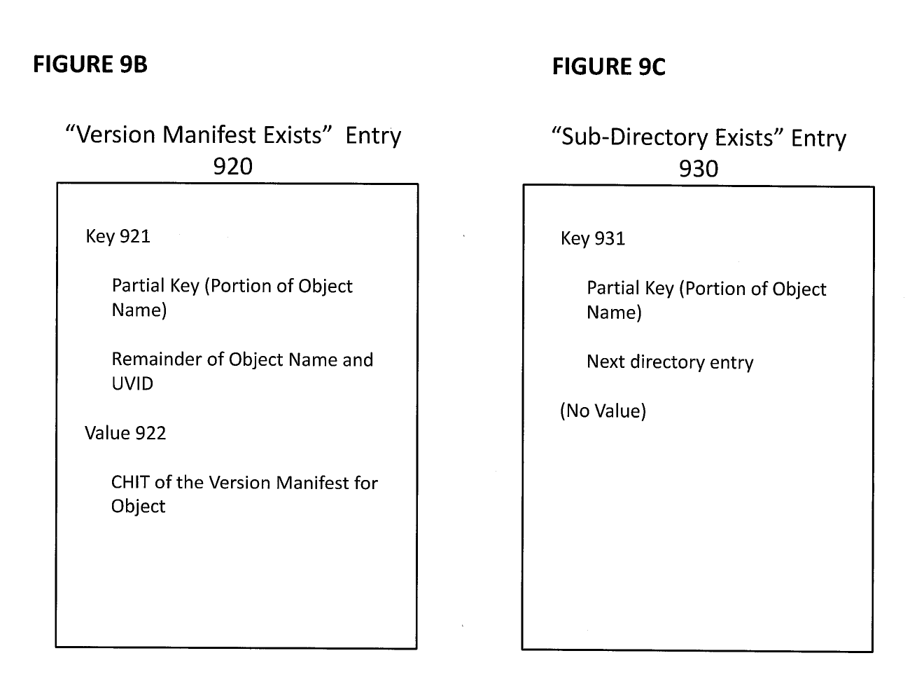

With reference to FIG. 9A, the relationship between object names and namespace manifest 810 is depicted. Exemplary name of object 910 is received, for example, as part of a put transaction. Multiple records (here shown as namespace records 931, 932, and 933) that are to be merged with namespace manifest 810 are generated using the iterative or inclusive technique previously described. The partial key has engine 930 runs a hash on a partial key (discussed below) against each of these exemplary namespace records 931, 932, and 933 and assigns each record to a namespace manifest shard, here shown as exemplary namespace manifest shards 810a, 810b, and 810c.

Each namespace manifest shard 810a, 810b, and 810c can comprise one or more entries, here shown as exemplary entries 901, 902, 911, 912, 921, and 922.

The use of multiple namespace manifest shards has numerous benefits. For example, if the system instead stored the entire contents of the namespace manifest on a single storage server, the resulting system would incur a major non-scalable performance bottleneck whenever numerous updates need to be made to the namespace manifest.

With reference now to FIGS. 9B and 9C, the structure of two possible entries in a namespace manifest shard are depicted. These entries can be used, for example, as entries 901, 902, 911, 912, 921, and 922 in FIG. 9A.

FIG. 9B depicts a “Version Manifest Exists” (object name) entry 920, which is used to store an object name (as opposed to a directory that in turn contains the object name). The object name entry 920 comprises key 921, which comprises the partial key and the remainder of the object name and the unique version identifier (UVID). In the preferred embodiment, the partial key is demarcated from the remainder of the object name and the UVID using a separator such as “i” and “\” rather than “I” (which is used to indicate a change in directory level). The value 922 associated with key 921 is the CHIT of the version manifest for the object 910, which is used to store or retrieve the underlying data for object 910.

FIG. 9C depicts “Sub-Directory Exists” entry 930. The sub-directory entry 930 comprises key 931, which comprises the partial key and the next directory entry. For example, if object 910 is named “/Tenant/A/B/C/d.docx,” the partial key could be “/Tenant/A/”, and the next directory entry would be “B/”. No value is stored for key 931.

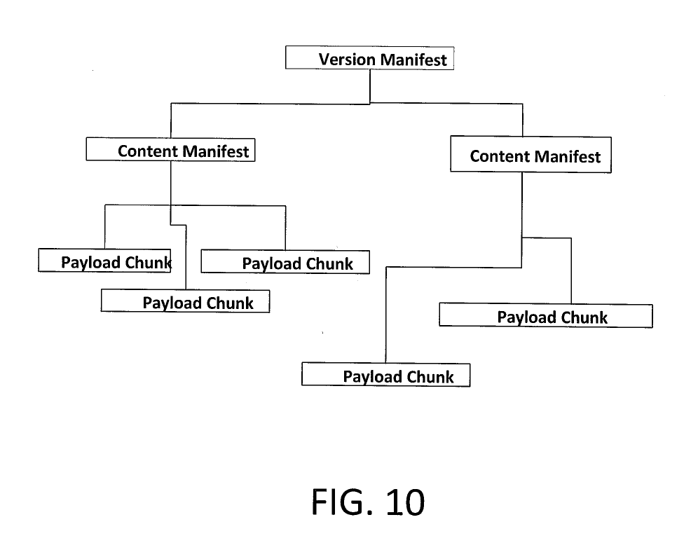

FIG. 10 depicts a hierarchical structure for the storage of an object into chunks in accordance with embodiment of the invention. The top of the structure is a Version Manifest that may be associated with a current version of an Object. The Version Manifest holds the root of metadata for an object and has a Name Hash Identifying Token (NHIT). As shown, the Version Manifest may reference Content Manifests, and each. Content Manifest may reference Payload Chunks. Note that a Version Manifest may also directly reference Payload Chunks and that a Content Manifest may also reference further Content Manifests.

In an exemplary implementation, a Version Manifest contains a list of Content Hash Identifying Tokens (CHITs) that identify Payload Chunks and/or Content Manifests and information indicating the order in which they are combined to reconstitute the Object Payload. The ordering information may be inherent in the order of the tokens or may be otherwise provided. Each Content Manifest Chunk contains a list of tokens (CHITs) that identify Payload Chunks and/or further Content Manifest Chunks (and ordering information) to reconstitute a portion of the Object Payload.

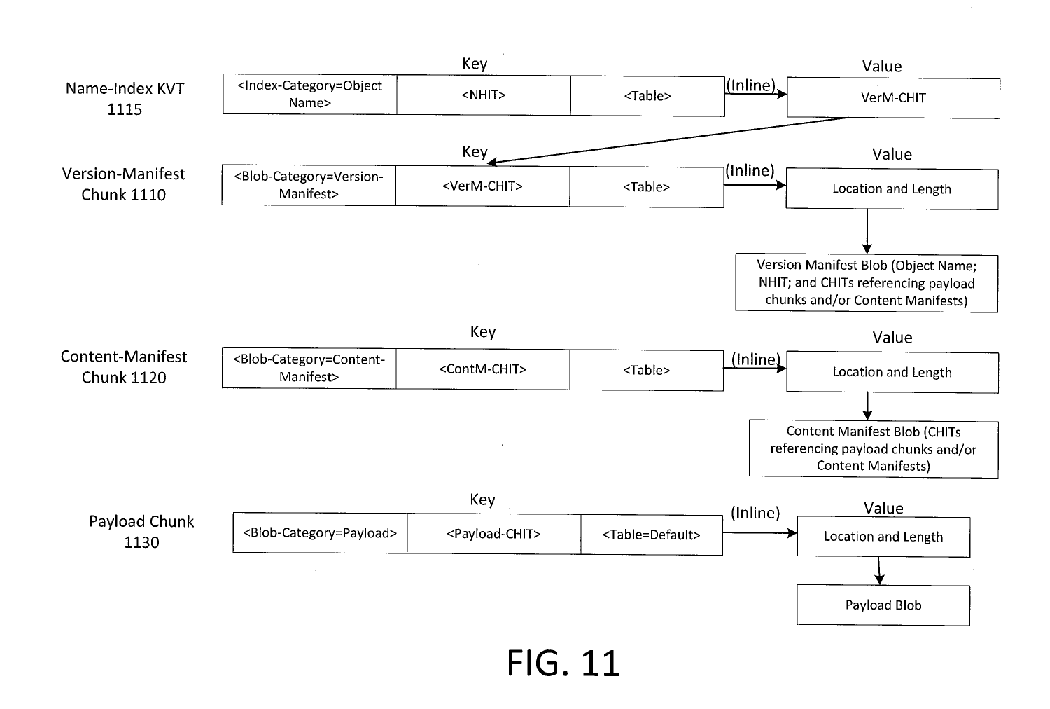

FIG. 11 depicts key-value tuples (KVTs) that are used to implement the hierarchical structure of FIG. 10 in accordance with an embodiment of the invention. Depicted in FIG. 11 are a Version-Manifest Chunk 1110, a Content-Manifest Chunk 1120, and a Payload Chunk 1130. Also depicted is a Name-Index KVT 1115 that relates an NHIT to a Version Manifest.

The Version-Manifest Chunk 1110 includes a Version-Manifest Chunk KVT and a referenced Version Manifest Blob. The Key of the Version-Manifest Chunk KVT has a <Blob-Category=Version-Manifest> that indicates that the Content of this Chunk is a Version Manifest. The Key also has a <VerM-CHIT> that is a CHIT of the Version Manifest Blob. The Value of the Version-Manifest Chunk KVT points to the Version Manifest Blob. The Version Manifest Blob contains CHITs that reference Payload Chunks and/or Content Manifest Chunks, along with ordering information to reconstitute the Object Payload. The Version Manifest Blob may also include the Object Name and the NHIT.

The Content-Manifest Chunk 1120 includes a Content-Manifest Chunk KVT and a referenced Manifest Contents Blob. The Key of the Content-Manifest Chunk KVT has a <Blob-Category=Content-Manifest> that indicates that the Content of this Chunk is a Content Manifest. The Key also has a <ContM-CHIT> that is a CHIT of the Content Manifest Blob. The Value of the Content-Manifest Chunk KVT points to the Content Manifest Blob. The Content Manifest Blob contains CHITs that reference Payload Chunks and/or further Content Manifest Chunks, along with ordering information to reconstitute a portion of the Object Payload.

The Payload Chunk 1130 includes the Payload Chunk KVT and a referenced Payload Blob. The Key of the Payload Chunk KVT has a <Blob-Category=Payload> that indicates that the Content of this Chunk is a Payload Blob. The Key also has a <Payload-CHIT> that is a CHIT of the Payload Blob. The Value of the Payload Chunk KVT points to the Payload Blob.

Finally, a Name-Index KVT 1115 is also shown. The Key of the Name-Index KVT has an <Index-Category=Object Name> that indicates that this index KVT provides Name information for an Object. The Key also has a <NHIT> that is a Name Hash Identifying Token. The NHIT is an identifying token of an Object formed by calculating a cryptographic hash of the fully-qualified object name. The NHIT includes an enumerator specifying which cryptographic hash algorithm was used as well as the cryptographic hash result itself.

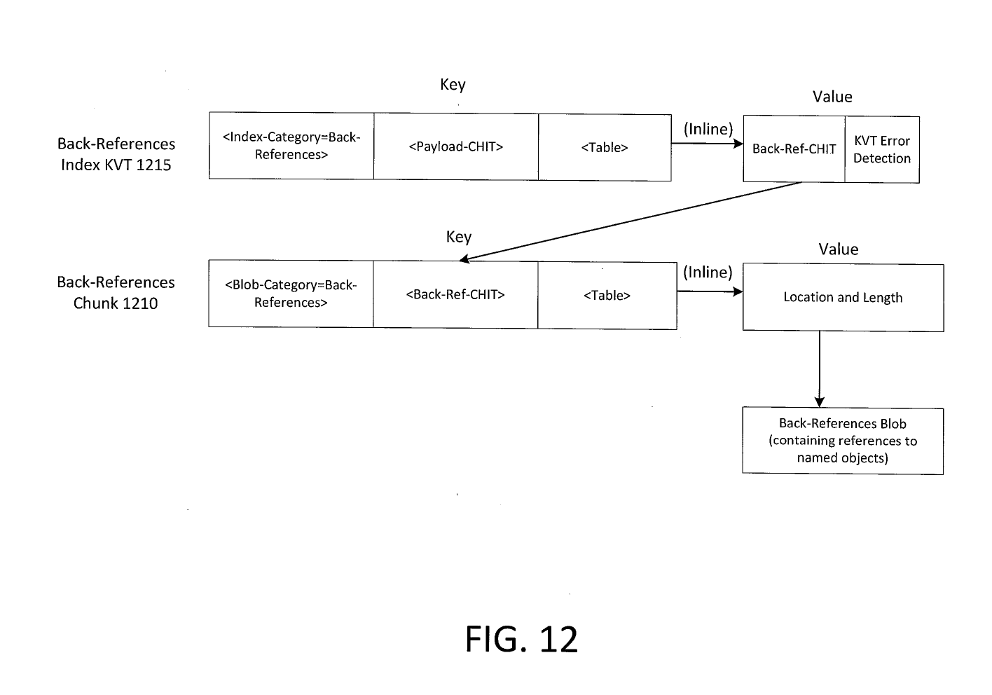

While FIG. 11 depicts the KVT entries that allow for the retrieval of all the payload chunks needed to reconstruct an object payload, FIG. 12 depicts KVT entries that allow tracking of all the objects to which a payload chunk belongs. The tracking is accomplished using back-references from a payload chunk back to objects to which the payload chunk belongs.

A Back-Reference Chunk 1210 is shown that includes a Back-References Chunk KVT and a Back-References Blob. The Key of the Back-Reference Chunk KVT has a <Blob-Category=Back-References> that indicates that this Chunk contains Back-References. The Key also has a <Back-Ref-CHIT> that is a CHIT of the Back-References Blob. The Value of the Back-Reference Chunk KVT points to the Back-References Blob. The Back-References Blob contains NHITs that reference the Name-Index KVTs of the referenced Objects.

A Back-References Index KVT 1215 is also shown. The Key has a <Payload-CHIT> that is a CHIT of the Payload to which the Back-References belong. The Value includes a Back-Ref CHIT which points to the Back-Reference Chunk KVT.

Simplified Illustration of a Computer Apparatus

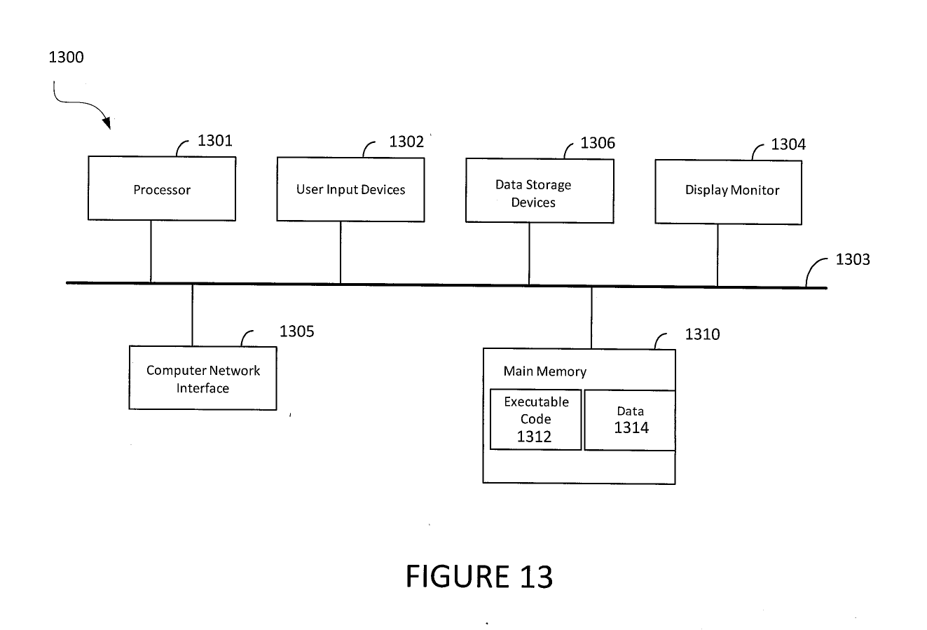

FIG. 13 is a simplified illustration of a computer apparatus that may be utilized as a client or a server of the storage system in accordance with an embodiment of the invention. This figure shows just one simplified example of such a computer. Many other types of computers may also be employed, such as multi-processor computers, for example.

As shown, the computer apparatus 1300 may include a microprocessor (processor) 1301. The computer apparatus 1300 may have one or more buses 1303 communicatively interconnecting its various components. The computer apparatus 1300 may include one or more user input devices 1302 (e.g., keyboard, mouse, etc.), a display monitor 1304 (e.g., liquid crystal display, flat panel monitor, etc.), a computer network interface 1305 (e.g., network adapter, modem), and a data storage system that may include one or more data storage devices 1306 which may store data on a hard drive, semiconductor-based memory, optical disk, or other tangible non-transitory computer-readable storage media 1307, and a main memory 1310 which may be implemented using random access memory, for example.

In the example shown in this figure, the main memory 1310 includes instruction code 1312 and data 1314. The instruction code 1312 may comprise computer-readable program code (i.e., software) components which may be loaded from the tangible non-transitory computer-readable medium of the data storage device 1306 to the main memory 1310 for execution by the processor 1301. In particular, the instruction code 1312 may be programmed to cause the computer apparatus 900 to perform the methods described herein.

What is claimed is:

1. A method of performing an update of key-value records in a shard of an object stored in a distributed object storage cluster, the method comprising:
sending a merge proposal with a size and content hash identifier of a delta chunk including the key-value records for the update from an initiator to all members of a shard group, wherein the members of the shard group are storage servers responsible for storing the shard of the object;
a first member of the shard group determining a transfer time for accepting transfer of the delta chunk, reserving local resources for the transfer, and sending a response including the transfer time to a next member of the shard group; and
the next member of the shard group determining when it is available to accept transfer of the delta chunk, changing the transfer time to a later time, if needed, and reserving local resources for the transfer.

2. The method of claim 1, further comprising:
determining whether there are any members of the shard group which have not yet received the response.

3. The method of claim 2, further comprising:
when there is a member which has not yet received the response, sending the response to the member.

4. The method of claim 2, further comprising:
when there is no member which has not yet received the response, then sending a final response, including the transfer time, to the initiator.

5. The method of claim 4, further comprising:
the initiator multicasting the delta chunk to all members of the shard group at a time based on the transfer time.

6. The method of claim 5, further comprising:
each member of the shard group creating a new master chunk for the shard that includes content of the current master chunk for the shard after the update from the delta chunk is applied.

7. The method of claim 5, further comprising:
each member of the shard group returning an acknowledgement message to the initiator after verifying the content hash identifier of the delta chunk and saving the update from the delta chunk in persistent storage.

8. The method of claim 1, wherein the object holds metadata for the distributed object storage cluster.

9. The method of claim 8, wherein the metadata comprises a namespace manifest for object names.

10. A method of performing a query for key-value records in an object stored in a distributed object storage cluster, the method comprising:
multicasting a query request from an initiator to a group of storage servers that hold shards of the object;
each recipient of the query request obtaining search results by searching for matching key-value records in a locally-stored shard of the object; and
each recipient determining whether a size of the search results is less than a threshold size.

11. The method of claim 10, further comprising:
when the size is less than the threshold size, generating a result chunk including the search results and sending the result chunk to the initiator.

12. The method of claim 11, further comprising:
when the size is greater than the threshold size, saving the search results in one or more result chunks and sending a message to the initiator the reports the content hash identifiers of the one or more result chunks; and
the initiator fetching the result chunks using the content hash identifiers.

13. The method of claim 10, wherein the object holds metadata for the distributed object storage cluster.

14. The method of claim 13, wherein the metadata comprises a namespace manifest for object names.

15. A system for an object storage cluster, the system comprising:
a storage network that is used by a plurality of clients to access the object storage cluster; and
a plurality of storage servers accessed by the storage network,
wherein the system performs steps to accomplish an update of key-value records in a shard of an object stored in the object storage cluster, the steps including:
sending a merge proposal with a size and content hash identifier of a delta chunk including the key-value records for the update from an initiator to all members of a shard group, wherein the members of the shard group are storage servers responsible for storing the shard of the object;
a first member of the shard group determining a transfer time for accepting transfer of the delta chunk, reserving local resources for the transfer, and sending a response including the transfer time to a next member of the shard group; and
the next member of the shard group determining when it is available to accept transfer of the delta chunk, changing the transfer time to a later time, if needed, and reserving local resources for the transfer.

16. The system of claim 15, wherein the steps further include:
determining whether there are any members of the shard group which have not yet received the response;
when there is a member which has not yet received the response, sending the response to the member; and
when there is no member which has not yet received the response, then sending a final response, including the transfer time, to the initiator.

17. The system of claim 16, wherein the steps further include:
the initiator multicasting the delta chunk to all members of the shard group at a time based on the transfer time.

18. The system of claim 17, wherein the steps further include:
each member of the shard group returning an acknowledgement message to the initiator after verifying the content hash identifier of the delta chunk and saving the update from the delta chunk in persistent storage; and
each member of the shard group creating a new master chunk for the shard that includes content of the current master chunk for the shard after the update from the delta chunk is applied.

19. The system of claim 18, wherein the object holds metadata for the object storage cluster.

20. The system of claim 19, wherein the metadata comprises a namespace manifest for object names.

21. A system for an object storage cluster, the system comprising:
a storage network that is used by a plurality of clients to access the object storage cluster; and
a plurality of storage servers accessed by the storage network,
wherein the system performs steps to accomplish performance of a query for key-value records in an object stored in the object storage cluster, the steps including:
multicasting a query request from an initiator to a group of the storage servers that hold shards of the object;
each recipient of the query request obtaining search results by searching for matching key-value records in a locally-stored shard of the object; and
each recipient determining whether a size of the search results is less than a threshold size.

22. The system of claim 21, wherein the steps further include:
when the size is less than the threshold size, generating a result chunk including the search results and sending the result chunk to the initiator.

23. The system of claim 22, wherein the steps further include:
when the size is greater than the threshold size, saving the search results in one or more result chunks and sending a message to the initiator the reports the content hash identifiers of the one or more result chunks; and
the initiator fetching the result chunks using the content hash identifiers.

24. The system of claim 21, wherein the object holds metadata for the distributed object storage cluster.

25. The method of claim 24, wherein the metadata comprises a namespace manifest for object names.
